(19) United States
(12) Patent Application Publication
(10) Pub. No.: US 2008/0317451 A1
(43) Pub. Date: Dec. 25, 2008

(54) A Traveling Camera Apparatus for Surfing

(76) Inventor: Justin Enjo, Melbourne Beach, FL (US)

Correspondence Address: JUSTIN ENJO, 120 MEDINA STREET, MELBOURNE BEACH, FL, 32951, US

(21) Appl. No.: 11/381,714

(22) Filed: May 31, 2006

(51) Int. Cl. G03B 17/08

(52) U.S. Cl. 396/25

(57) ABSTRACT

The Traveling Camera Apparatus for Surfing is embodied to film and photograph a surfer in motion on a breaking wave. The Traveling Camera Apparatus for Surfing is intended to have a full range of motion with functionality in 6 degrees of freedom and with the ability to operate in and out of the water. The advent for such an apparatus is motivated by the advance of the surfing photography/videography industry. The economic feasibility of the invention is spawned by the advent of wavepools equipped with breaking wave making devices that impart to creating breaking waves for surfing in a controlled environment. In such a wavepool a surfer may travel an entire length of the wavepool as permitted by the propagation of the breaking wave. The Traveling Camera Apparatus for Surfing shall be designed to follow along side the subject and create a multitude of images not possible if the camera were stationary in the wavepool. Some popular and sought after vantage points in the surfing photography industry are obtained when the camera is located directly behind the surfer submerged in the breaking wave and directly adjacent to the surfer where the camera is actually submerged in the water body of the breaking wave. In order to film the motion the surfer over the entire duration of the breaking wave, these camera angles require that the camera actually travel a path across the pool similar to that of the surfer on the breaking wave.

### BACKGROUND OF THE INVENTION

The invention begins by making two assumptions in that (1) there is a wavepool with breaking waves and (2) that these breaking waves can be ridden by a subject. Over 500 wavepools exist in the world today for the applications of hydrodynamic studies, wave theory study, the study of ships in a seaway, weather modeling, and recreation.

A wavepool in this document relates to the subject of recreation in that the subjects ride the breaking waves for recreation. Notwithstanding the application of a Traveling Surfing Apparatus for Surfing is applicable in all types of wavepools for all types of filming applications. However, the primary sought after camera view of the Traveling Camera Apparatus for Surfing is obtained from viewing the subject when the camera is positioned inside the water body of the breaking wave.

It should be noted that the application of the Traveling Surfing Apparatus for Surfing does in fact extend beyond the boundaries of a wavepool. Currently breaking waves are ridden by people in the world's oceans and lakes. This camera apparatus could be installed in a lake or over a reef in the ocean. The advent of this invention may lead to these future applications of the invention however a certain amount of limiting factors does hinder this application of the invention. For example installing the apparatus on a reef would require a great deal of permits especially concerning environmental impacts, storm/disaster planning, and construction obstacles such as supplying power and machinery to remote aquatic environments. A wavepool offers a completely human controlled environment greatly simplifying the installation and operation such an apparatus.

Pioneers of the surfing photography and surf videography industry field are continually making efforts at filming a subject on a breaking wave through a vast array of techniques and camera positions to create some interesting and very amusing effects. The following examples show both the creative extents at which some cameramen have gone to capture rare and exciting surfing footage, as well as their costly and time consuming drawbacks.

A recent motion picture dedicated to the surfing genre filmed a frontal view of surfing by placing a camera man sitting on the back of a PWC (personal water craft such as a jet ski). The camera filmed the motion of the surfer while the PWC cruised along at the same speed as the surfer. The cameraman successfully followed the surfer's motion along the path of the breaking wave but at a cost. The action of the PWC in front of the surfer causes disturbances to the water surface of the wave due to the wake of the PWC. Unless the water surface is smooth, the operation of the PWC may be bumpy and cause difficulties in capturing steady video footage.

A large surfing merchandise company filmed an advertisement campaign in which two professional surfers jumped out of a helicopter with their surf boards. The cameraman filmed those surfing the breaking waves from the helicopter. The overhead or bird's eye vantage point created rarely scene views of the surfers. However, the overhead footage required the usage of a helicopter. For the majority of the population the access to a helicopter for the means of filming surfing for recreation is uneconomical and costly. To make overhead or bird's eye filming accessible and affordable to the general public a helicopter should not be the primary means of acquiring this vantage point.

Another camera angle can be captured from a rarely scene underwater vantage point. In the circumstance that a cameraman is underwater they can film the passage of a surfer on a breaking wave as the camera looks at the subject from underwater or from inside the water body of the breaking wave. The motion of the surfer is actually distorted somewhat by the surface of the water however creating an interesting video effect. In the case of the underwater footage, the cameraman films the surfer while the surfer passes by on the breaking wave. In this case the cameraman has very limited mobility and can only pan the camera and adjust the zoom simultaneously to capture the surfer in passing. It is impossible for the cameraman to swim fast enough underwater to film the entire duration of the surfer's ride.

The camera angle from inside the water body of the breaking wave is the primary motivation for the invention. This camera angle from inside the water body of the breaking wave creates dazzling and stunning views which are rarely, if ever, seen by the general public. Surfing is a water sport and the camera angles achieved from the water angle from inside the water body of the breaking wave complement the artistic form of surfing.

The only current comparison to the invention on the market today would be seen during a televised swimming event. During the Olympics the major TV networks have cameras placed at various locations underwater in the pool. These cameras pan and travel to follow the motion of the swimmers in each lane and give the audience a chance to see the motion of the swimmers from above water and below water. Most views from above water show the arm motion and the wake of the swimmers, coupled with the whitewater and turbulence created by the swimmer; viewing swimming from outside the pool shows little into the motion and behavior of the swimmer as compared to viewing the swimmers from underwater.

The main idea behind the Traveling Camera Apparatus for Surfing is to capture these camera angles quickly, easily, and economically without the need of a jet ski, a helicopter, or being able to swim 15 mph underwater. The apparatus would allow the operator to configure a path for a camera to travel. This path would follow the surfer for their entire duration on the wave while filming the surfer at any vantage point specified by the operator.

### DISCLOSURE OF THE INVENTION

The claims set forth by this report highlight the basic principles of the invention. The preferred embodiment of the invention relates generally to methods and apparatus for use in connection with underwater video equipment and more particularly, a method and a system for moving the underwater video equipment while completely submerged.

A surfer or subject shall travel a path on a breaking wave in a wavepool while being filmed by a camera that travels a path similar to the subject. Generally the subject will travel a path in the wave pool that extends from one corner to a diagonally opposite corner of the wave pool. The camera shall remain in close proximity to the subject for the duration of the subject's ride on the breaking wave.

The major task of the apparatus is to travel across the wavepool in this close proximity to the subject. Considering the scale involved here, a surfer may travel up to 100 yards or 300 feet in a large Olympic sized wavepool on a breaking wave up to 6 feet high.

### SUMMARY OF THE INVENTION

The apparatus shall consist of a camera, camera housing, traveling device, suspension system and mounting system. The apparatus shall be placed in a wavepool containing breaking waves that are rode by subjects for recreation.

A brief summary is supplied to describe the wavepool and the conditions encountered by the apparatus in the wavepool to facilitate the understanding and application of the invention. Many variations of the present invention within the scope of the claims stated shall be apparent to those skilled in the art once the principles described herein are understood.

The wavepool shall be described as a large body of water with a wave making device capable of creating breaking waves. The breaking waves referred to can be of type spilling, surging, or plunging and shall peel accordingly to allow a subject to ride the waves for recreation.

The wavepool shall confine an environment conducive to the subjects in the wavepool. The environment shall possibly include all solutions of water that are deemed suitable for human interaction including but not limited to fresh water, distilled water, salt water, brackish water, chlorinated pool water, or brine water. For the replication of surfing, ocean salt water is most appropriate.

The subject shall be a person who uses the wavepool for sport or recreation. Some examples of subjects include but are not limited to body surfing, board surfing, windsurfing, kite boarding, kayaking, swimming, or jet skiing. The subject could also be shall be any animal or object that may interact with breaking wave in the wavepool. Examples of animals that can interact with the breaking wave and apparatus includes but are not limited to dolphins, penguins, sea gulls, dogs, fish, and sharks. Examples of objects animals that can interact with the breaking wave and apparatus includes but are not limited to model boats, model submarines, and unmanned submarines.

The camera used in this apparatus can be either type analog, digital, infrared, laser, or photographic and the type has no bearing on the application of the invention. It is expected though, that with a working prototype of the invention, many professional filming and photography techniques can be applied to optimize the performance of the invention.

The camera will have all configurable functionality to adjust to exposure, light, environment, speed or action of the said subject, focus, zoom, and quantity of photographs or duration of film as specified by the said operator. Examples of functionality and adjustability of the camera includes but is not limited to auto and manual focus, digital and optical zoom, wide angle and telescopic lenses, light filters, night vision, and high density and low density filters.

For example, the invention will allow users to take underwater pictures moving at given velocities. This provision shall require photographers to adjust film exposure, shutter speed, light exposure, focus, lens selection and a wide variety of other variables related to manipulating viewing for subjects in motion.

For photographs and footage taken from inside the water body of the breaking wave (underwater); the photographer is looking at a subject on the water surface of the breaking wave. Another group of parameters affect the image capturing process in this situation. The physical, mechanical, and chemical properties of water affect the image capturing process that include but are not limited to light reflection, surface distortion, light refraction, light scattering, turbidity, density, salinity, temperature, conductivity, changes in dissolved solids, liquids and gases, and visibility.

The camera shall be contained in a camera housing that is designed to protect and secure the camera in the environment of the wavepool. The camera will he housed by a casing designed to keep the camera dry and free from water and moisture, attach the camera to the traveling device, and that is hydro dynamically designed to travel underwater. The camera housing shall also protect the camera from underwater pressures up to the maximum depths of the wavepool and the maximum hydrostatic pressure experienced by the breaking wave, and have impact strength to withstand a surfer or subject possibly colliding or falling on the camera housing, and to also have a view window adequate not to constrict the lens of the camera.

Generally a fiberglass, PVC, epoxy, carbon fiber, elastomer, composite, plastic or rubber polymer will be used as the primary construction for the camera housing and contain moisture retarding insulation and desiccants. The housing will also be expected to operate in a range of temperature and weather conditions similar to the range that the wavepool might experience.

The camera housing shall be designed to withstand the forces of the environment with all applied factors of safety and material design constraints. The major forces possibly experienced by the housing are impact pressures from colliding with a surfer or the impact pressures of a breaking wave. The camera will be exposed to hydrostatic pressure with a maximum at the bottom of the pool underneath the water column including the height of the breaking wave. In any case the housing will be designed to withstand these forces with an adequate factor of safety.

The camera is designed to move with the surfer and the breaking wave from any point in the wave pool to any other point in the wave pool as specified by an operator. In the case of many rectangular shaped wavepools surfers travel from one corner of the wavepool to the diagonally opposite corner of the wavepool according to the propagation of the breaking wave.

The camera housing will be required to travel under water at speeds similar to a surfer traveling on a breaking wave. Surfers travel at speeds of 10 to 20 mph, frequently a little faster than the speed of propagation of the breaking wave. The hydrodynamics of the housing should allow the camera to travel underwater without causing obstruction to the view of the camera lens. A poorly streamlined housing will cause cavitations and bubbles will form that will restrict the camera's view of the subject. The housing will also have a viewing window that does not restrict the vision of the camera lens. A poorly streamlined housing will also generate a good deal of drag and require larger amounts of energy to drive the housing through the water.

The camera housing moves along with the surfer by means of a traveling device. The traveling device used to move the camera housing may be any type of mechanical system by which the camera housing can be powered. Some examples include a gear motor inside the camera housing that allows the housing to travel along a cord or a wire. Other examples of the traveling device includes but are not limited to a pulley system, a chain link and wheel system, a magnetic system, a spooled wire system, powered car system, and a wire and traveling car system.

In these examples the traveling device is incorporated into the camera housing. In this case the camera housing shall be powered to move along a suspension system. The suspension system supplies a structure that follows a path in close proximity to the subject. Some examples of elongated structures that shall act as the suspension system include but are not limited to a chain, chord, wire, rope, tension chord, shock chord, shroud line, line, bar, track or strut. The traveling device and the suspension system shall couple to one another accordingly.

The suspension system shall span the wavepool to create this path for the camera to travel. The orientation of the suspension system governs the path of the camera relative to the subject. For example if the traveling device is a gear box that moves on a chain suspension system, the orientation of chain shall govern the path of the camera.

In another example the camera housing may be permanently fixed to the suspension system. If the suspension system is a rope and the ends of the rope are gathered by spools, the movement of the spools governs the motion of the camera. In this case the suspension system must move to drive the camera along a path with the subject. In this example the moving suspension system shall be considered the traveling device.

The suspension system shall be attached to the wavepool by a mounting system. The elongated structure of the suspension system shall terminate at the mounting system. The position of the mounting system on the wavepool shall be configurable to adjust to the path of the subject. For the chain and gear box example, the chain is suspended across the wavepool and attached at either end at the mounting system. By moving the mounting system, the operator can vary the path that the camera travels along the suspended chain.

### BRIEF DESCRIPTION OF THE DRAWINGS

FIG. 1 is a perspective view of the wavepool with a breaking wave propagating across the wavepool. The breaking wave is propagating from the upper left hand corner of the pool to the lower right hand corner. FIG. 1 is also front view of the wavepool.

FIG. 2 is a perspective view of the wavepool with breaking wave propagating across the wavepool. The orientation of FIG. 1 has been rotated 90° and is now a side view.

FIG. 3 is a perspective view of the surfer traveling along the breaking wave. The view shall also be considered an overhead view looking down onto the wavepool.

FIG. 4 is a side view of the breaking wave similar to FIG. 2 but zoomed in considerably. The observer is standing much closer to the breaking wave.

FIG. 5 is a side view of the breaking wave with a surfer traveling on the breaking wave. The view is similar to FIG. 4 but a subject has been placed on the wave. The surfer and the breaking wave are propagating towards the viewer out of the page.

FIG. 6 is a side view in FIG. 5. The ovals are examples of paths that the camera shall travel into and out of the page.

FIG. 7 is the side view in FIG. 6 rotated slightly to the right. The view has more of a 3D appeal in that the ovals have been replaced by a sphere around the surfer.

FIG. 8 is a perspective view of the surfer on the breaking wave, similar to FIG. 3, accompanied by four embodiments of the traveling camera apparatus.

FIG. 9 is a perspective view, similar to FIG. 5, which shows the surfer on the breaking wave accompanied by four embodiments of the traveling camera apparatus.

FIG. 10 is a perspective view similar to FIG. 9 zoomed out that shows the surfer on the breaking wave accompanied by four embodiments of the traveling camera apparatus.

FIG. 11 is a perspective view, similar to FIG. 3, embodying the traveling camera apparatus suspended above the wavepool.

FIG. 12 is a perspective view embodying a stanchion for the suspended camera mounting system.

FIG. 13 is a perspective view highlighting the suspended traveling camera apparatus with motion of the apparatus highlighted by 3 degrees of freedom in 3D space.

FIG. 14 is a perspective view of the suspended camera, telescoping pole, and traveling device.

FIG. 15 is a perspective view of the suspended camera traveling device.

FIG. 16 is a perspective view of the suspended camera apparatus with the camera in the camera housing with a protective lens.

FIG. 17 is a perspective view, similar to FIG. 7, embodying 3 camera apparatus at different orientations relative to the surfer.

FIG. 18 is a perspective view of the camera housing used for the wave camera and the underwater camera.

FIG. 19 is a section view of FIG. 18 showing the inside of the underwater camera housing; also the same housing used for the wave camera.

FIG. 20 is a perspective view of the wave camera mount and the underwater camera mount.

FIG. 21 is a perspective view, zoomed in, of the wave camera mount.

FIG. 22 is a perspective view, zoomed in, of the underwater camera mount for underwater camera.

FIG. 23 is an overhead perspective view embodying the bottom track and the bottom camera.

FIG. 24 is a perspective view of the bottom camera mounted to the bottom of the wavepool.

FIG. 25 is a perspective view of the surfer on the breaking wave. FIG. 25 is a front view of FIG. 1. The observer sees the surfer in front of the water body of the breaking wave.

FIG. 26 is a perspective view of the surfer on the breaking wave. FIG. 26 is a back view of FIG. 1. The observer sees the surfer by looking through the water body of the breaking wave.

### DETAILED DESCRIPTION OF THE PREFFERED EMBODIMENT

All figures show the surfer and the breaking wave traveling in the same direction, regardless of the orientation of the figure. Every object in every figure also remains static for the remainder of the report. Motion and paths of motion are mentioned and described in the patent but no sequential figures or “before and after” figures are given that show displacement of an object described to be in motion. Only the view or the orientation of the viewer changes with respect to the subject.

This presentation of the material is straight forward and in simplistic terms. By not changing the positions of the subject, breaking wave, camera, camera housing, suspension system, or mounting system, the presentation of the material becomes simpler.

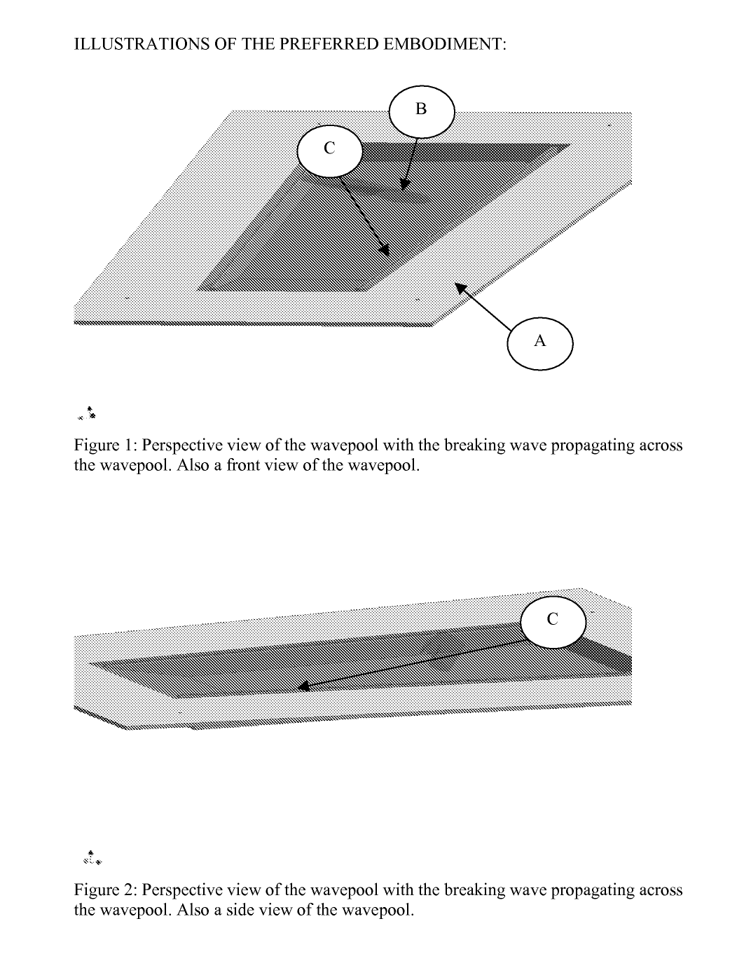

FIGS. 1 to 26 are snapshots taken from a 3D rendering of apparatus. These figures are used to describe the embodiment of the invention and give the reader a detailed description of the inventions components and functionality.

FIG. 1 is perspective view of the wavepool with a breaking wave propagating across the wavepool. The view is also a front view. The wavepool (A) is indicated and the arrow is touching the deck of the wavepool (A) itself.

Referring to FIG. 1, the wavepool is about the size of a large swimming pool by today's standards. An example is a large Olympic swimming pool. The deep end is located in the back of the pool where the breaking wave (B) actually forms and then travels towards the viewer to the shallow end of the pool. The breaking wave travels along the path highlighted by vector (C) or actually, a surfer traveling on the wave would have a net velocity along the vector (C).

FIG. 2 is a perspective view of the wavepool with the breaking wave propagating across the wavepool. The orientation of FIG. 2 has been rotated towards the right becoming a side view of FIG. 1. The path highlighted by (C) in FIG. 1 is the same path traveled (C) by the surfer in FIG. 2.

Referring to FIG. 2, the key feature of the breaking wave is the path that the wave travels in the wavepool. The peel angle, or the propagation of the breaking wave, follows a path similar to vector (C) across the pool. The subject shall follow a similar path

FIG. 3 is a perspective view of the surfer (E) traveling along the breaking wave. The view is an overhead view of FIG. 1 looking down onto the wavepool. The surfer (E) is traveling along with the breaking wave in direction (C). The breaking wave (B) is also traveling in a net direction (C).

Referring to FIG. 3, the water surface (D) of the pool is a flat surface parallel to the deck of the wavepool (A).

Referring to FIG. 3, the wavepool is deep enough to create a wave the same height as the surfer. The surfer in the picture is an average height at 6 feet tall. The figures are not to scale but provide a realistic perception of the size of the subject and the breaking wave.

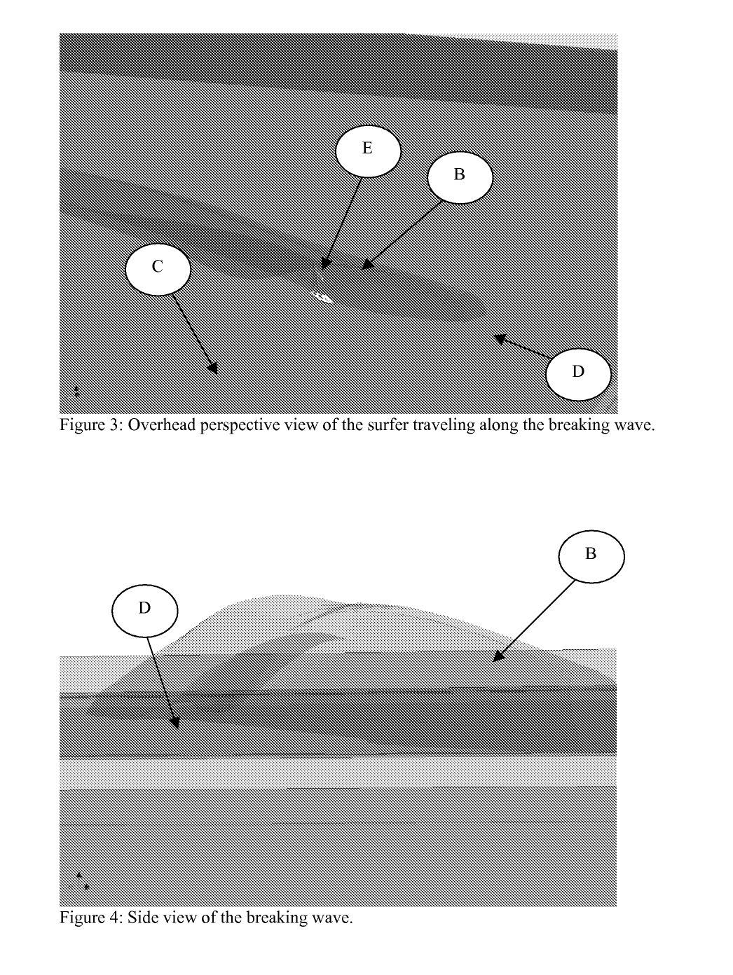

FIG. 4 is a side view of the breaking wave (B). FIG. 4 is the same view from FIG. 2 but the viewer has moved closer to the breaking wave. The water surface (D) of wavepool is slightly lower than the pool deck of the wavepool (A) similar to a swimming pool.

Referring to FIG. 4, it can be seen from this view that there is a considerable amount of water in the body of the breaking wave (B) and that this water body is above the wavepool (A) and the water surface (D).

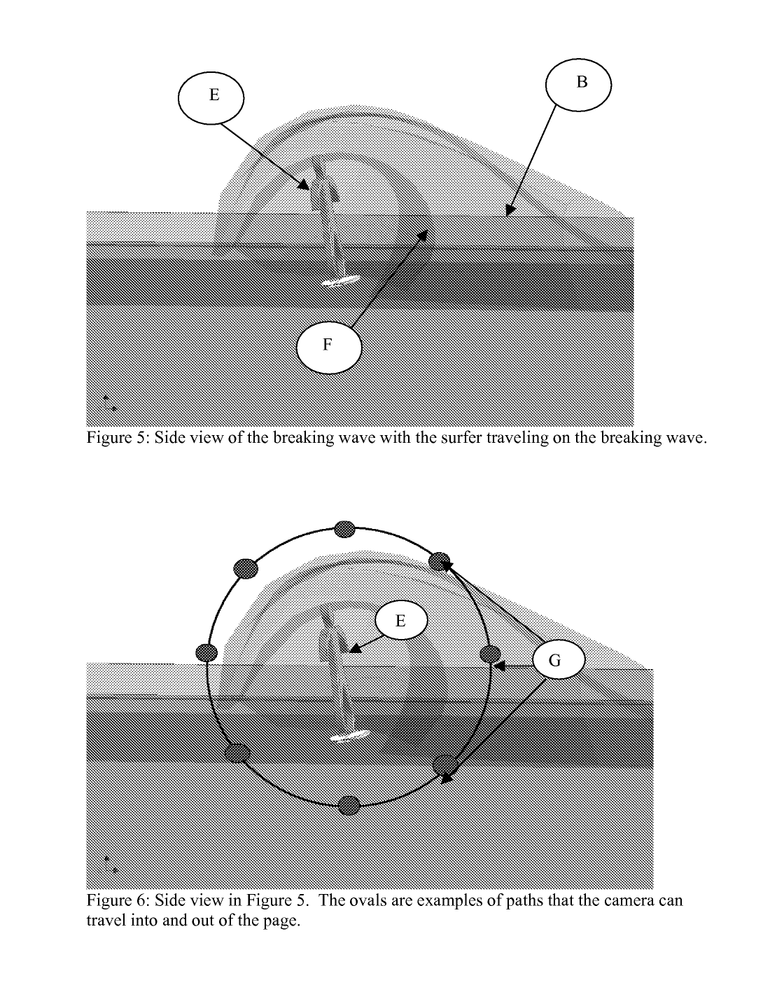

FIG. 5 is a side view of the breaking wave (B) with the surfer traveling on the breaking wave. FIG. 5 is a side view of FIG. 3. The net velocity of the surfer in FIG. 5 is towards the viewer out of the page. The surfer travels on the surface of the breaking wave and the surface of the wavepool.

Referring to FIG. 5, this water/wave surface can be considered an interface between the water and the air and is highlighted by (F).

Referring to FIG. 5, the motion of the surfer or the path that the surfer travels on the water surface of the wave is best described by example. The surfer moves similar to a skateboarder, a snow skier, or a snowboarder moving on a halfpipe. Snowboarders and skateboarders use gravity, primarily, to travel back and forth on the halfpipe. The breaking wave is actually a quarter pipe (one half of a halfpipe). Gravity still plays a roll, but the hydrodynamic relationship between the surfer, the surfboard, and the breaking wave mainly contribute to the surfer's motion. The surfer's motion is thus similar to a skateboarder or snowboarder traveling up to the top of the quarter pipe, down to the bottom, and thus returning as long as the breaking wave continues to propagate. The displacement of the subject and the breaking wave is towards the observer out of the page.

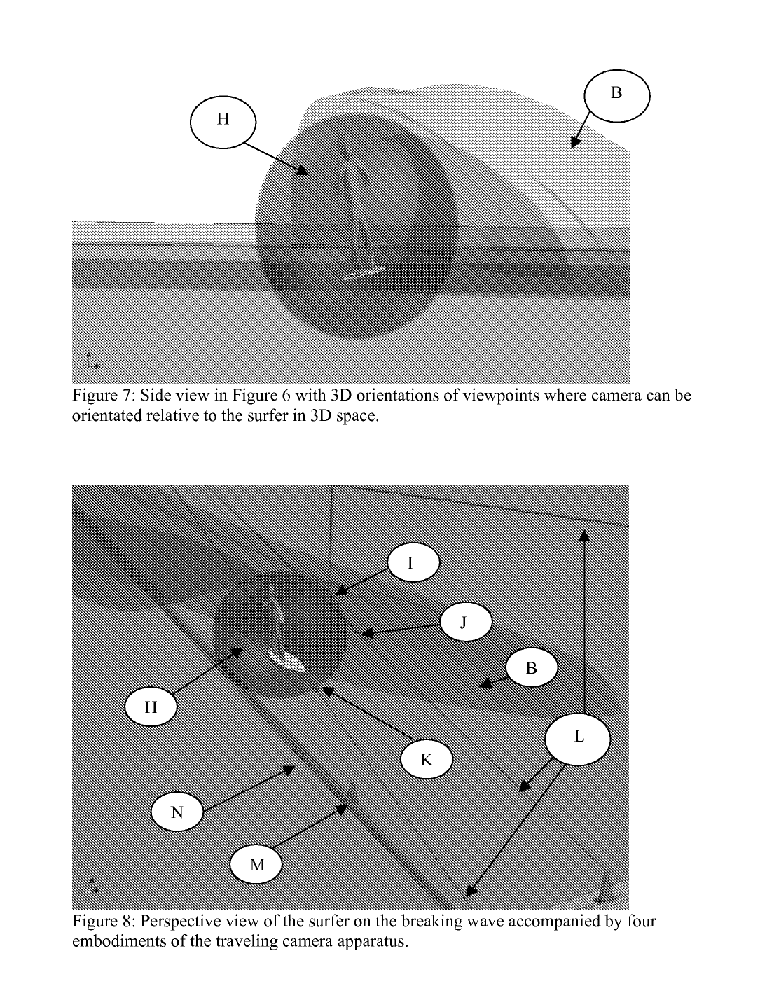

FIG. 6 is the side view in FIG. 5 with 2D orientations of paths, signified by the ovals (G) that the camera can travel into and out of the page. If FIG. 6 is considered a 2D picture, an oval could be orientated at any point along the circle.

Referring to FIG. 6, for example, a camera located at the oval above the surfer would film the surfer from an over head of bird's eye view. A camera located at the oval below the surfer would film the surfer from a view below the surfer and underwater.

FIG. 7 is the same as FIG. 6 with a 3D perspective adapted. The 2D ovals have been replaced with a sphere (H). Conceptually, while the surfer travels along the breaking wave the camera can be orientated at any point in proximity to the subject as signified by the sphere. In other words, the camera can film the surfer from any angle in space. The sphere (H) conceptually shows all the orientations of the camera relative to the surfer in 3D space.

Referring to FIG. 7, for example, the camera can be orientated at the stomach level of the surfer and be submerged in the water body of the breaking wave (B). Referring to FIG. 7, another example; the camera could be orientated at the shoulder level of the surfer in front of the surfer and be suspended in the air.

Referring to FIG. 7, still another example; the camera could also be completely submerged in the water body of the wavepool underneath the surfer. The orientation of the camera is solely based on operator preference and the desired angle to capture the surfer/subject on the wave.

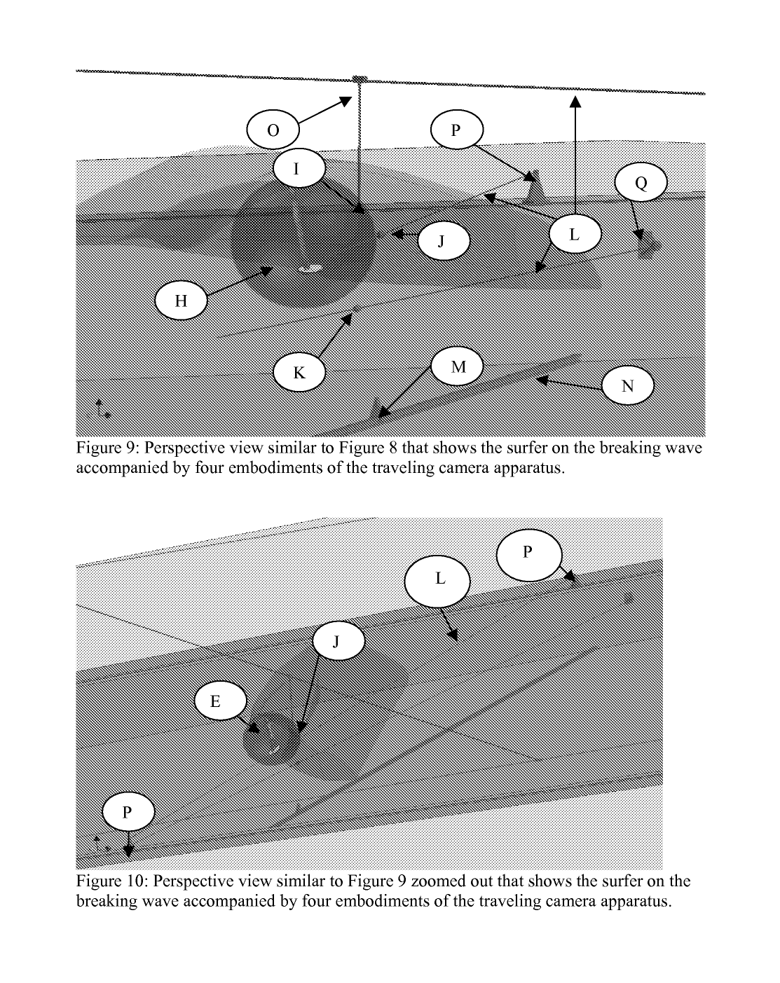

FIG. 8 is a perspective view of the surfer on the breaking wave accompanied by four cameras, camera housings, traveling devices, suspension systems, and mounting systems. FIG. 8 shows four examples of the traveling camera apparatus. The four cameras are signified by (I), (J), (K), and (M).

Referring to FIG. 8, the four cameras (I), (J), (K), and (M), all travel paths at orientations in close proximity to the subject. The cords (L) show the elongated structures that make up the suspension system. Suspended camera (I) is attached to the camera housing pole that is suspended from a cord (L). This camera configuration may be used to film the surfer from over head and aerial viewpoints.

Referring to FIG. 8, wave camera (J) travels along a similar cord (L) and is submerged in the water body of the breaking wave (B). This camera is mounted at the waist level of the surfer and films from an underwater perspective from inside the water body of the breaking wave.

Referring to FIG. 8, underwater camera (K) travels along a cord (L) and is positioned underneath the surfer submerged in the water body of the wavepool.

Referring to FIG. 8, bottom camera (M) is physically attached to the bottom of the wavepool and travels along track (N) affixed to the bottom of the wave pool as well. Track (N) is another example of a suspension system.

FIG. 9 is a perspective view similar to FIG. 8 that shows the surfer on the breaking wave accompanied by four traveling camera apparatus. The four cameras (I), (J), (K), and (M), are all mounted at orientations in close proximity to the surfer.

Referring to FIG. 9, suspended camera (I) films the surfer from an overhead view while traveling on a cord (L). The suspended camera (I) is mounted to the cord (L) by the traveling device (O).

Referring to FIG. 9, the wave camera (J) is inside the water body of the breaking wave and travels along suspension cord (L). This suspension cord terminates at the mounting system (P). This mounting system (P) is secured to the deck of the wavepool, above the water surface of the wavepool, in order to let the wave camera (J) travel inside the water body of the breaking wave along the suspension system.

Referring to FIG. 9, underwater camera (K) underwater and underneath the surfer moves along a cord (L) and is mounted by structure (Q). Mounting system (Q) is fixed to the sides of the wavepool underneath the water surface of the pool.

Referring to FIG. 9, bottom camera (M) is show where it travels along track (N) fixed to the bottom of the wavepool. Track (N) is an example of a suspension system that is mounted under the support of its own structure and no separate mounting system is required.

FIG. 10 is a perspective view similar to FIG. 9 zoomed out that shows the surfer on the breaking wave accompanied by four embodiments of the traveling camera apparatus. This view will highlight the traveling camera apparatus highlighted by wave camera (J), suspension system cord (L), and mounting system (P). The suspension cord (L) shall be seen to span the entire width of the wavepool and terminate at mounting systems (P).

Referring to FIG. 10, as the surfer (E) travels across the pool, the cameras must follow the surfer (E) across the pool to maintain a uniform close proximity to the surfer. This concept is especially important for the underwater photography. The object of the camera is to capture the entire behavior of the surfer (E) from a close proximity to the surfer.

Referring to FIG. 10, for example, the wave camera (J) is traveling inside the water body of the breaking wave and must remain inside the water body of the breaking wave to acquire the desired filming effect for the entire duration of the surfer's ride on the breaking wave.

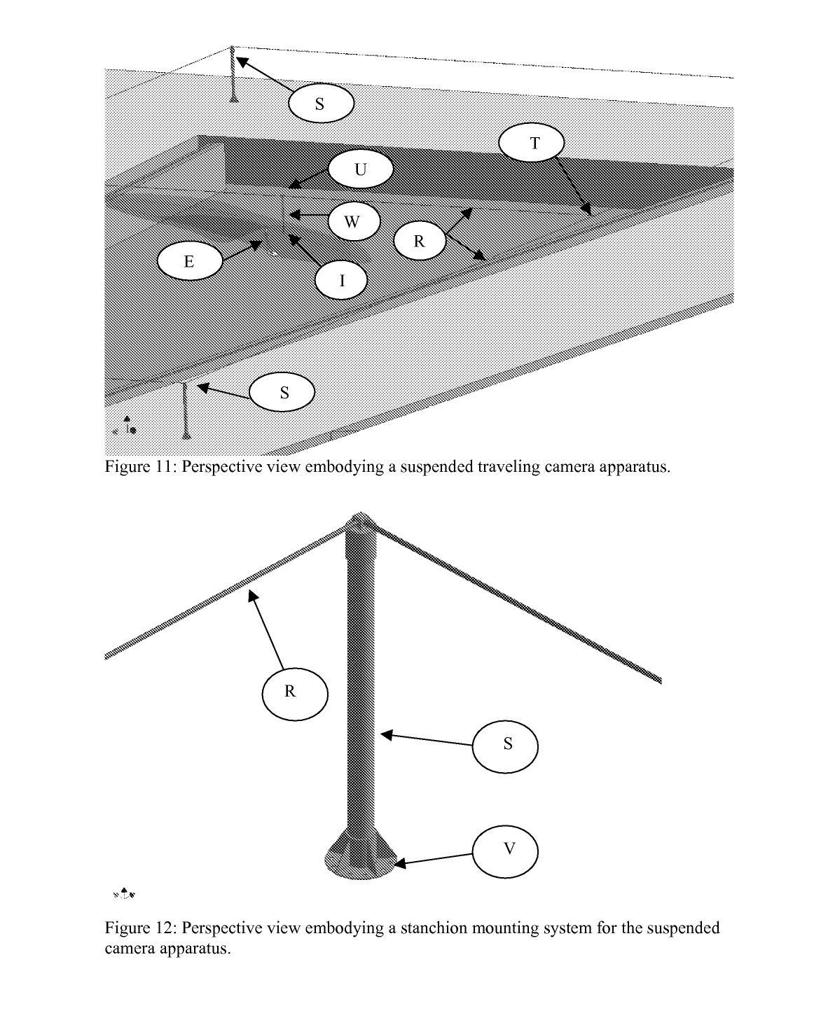

FIG. 11 is a perspective view embodying a traveling camera apparatus suspended above the wavepool and the breaking wave. Suspended camera (I) is suspended so that the camera may film over head views of the surfer (E) from close proximity. In this preferred embodiment the suspended camera (I) is attached to a pole (W) that moves along the suspension cords (R) by the traveling devices (U) and (T).

Referring to FIG. 11, the suspended camera (I) has the ability to move in all directions x, y, and z by adapting a Cartesian coordinate system. Traveling device (T) allows the camera (I) to move long ways along the wavepool. The traveling device (U) allows camera (I) to move width wise along the wavepool.

Referring to FIG. 11, the entire suspension system is comprised of cords (R). The suspension system is supported by a mounting system comprised of stanchions (S) located at the four corners of the wavepool. Two of the stanchions (S) are visible in FIG. 11.

FIG. 12 is a perspective view highlighting a stanchion mounting system, shown in FIG. 11, for the suspended camera apparatus. The stanchion (S) is mounted to the wavepool deck by a mounting plate (V). The suspended cord (R) is elevated above the water surface of the wavepool in order to obtain aerial and overhead views of the breaking wave and the surfer while the surfer moves along the breaking wave.

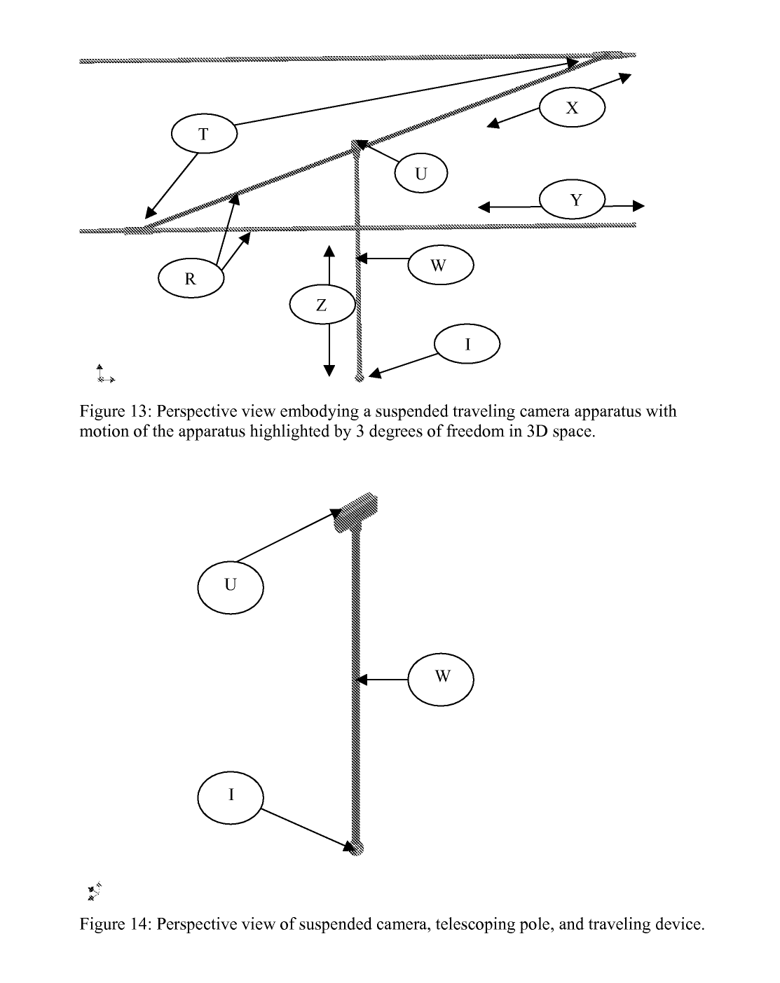

FIG. 13 is a perspective view highlighting the suspended traveling camera apparatus with motion of the apparatus highlighted by 3 degrees of freedom in 3D space. The traveling camera apparatus is comprised of the suspended camera (I), the pole (W), the 3 traveling devices (U) and (T), the suspension system of cords (R), and the stanchion mounting system (not shown, see FIG. 12).

Referring to FIG. 13, by adapting a Cartesian coordinate system the motions of the suspended camera are described by the directions (X), (Y), and (Z). The suspended camera (I) moves up and down along the direction (Z) with the motion of a telescoping pole (W). The telescoping pole is mounted to a traveling device (U) that is free to move into and out of the page along the direction (X). The apparatus previously mentioned moves left and right in the page along the direction (Y) with the traveling devices (T).

Referring to FIG. 13, this example highlights the necessity of motion in 3D space required for the suspended apparatus to move with the surfer and the breaking wave.

FIG. 14 is a perspective view of suspended camera (I), telescoping pole (W), and traveling device (U). The suspended camera (I) is designed to obtain a multitude of pictures of the surfer on the breaking wave from a large range of viewpoints. The suspended camera (I) can be used for overhead and aerial shots as well as images from inside the water body of the breaking wave.

Referring to FIG. 14, the height of the suspended camera (I) is adjusted by the telescoping pole (W). A retractable and extending telescoping pole (W) would allow for motion in the direction (Z), highlighted in FIG. 13. The suspended camera (I) and the telescoping pole (W) is mounted to the suspension cords (R not shown see FIG. 13) by a traveling device (U).

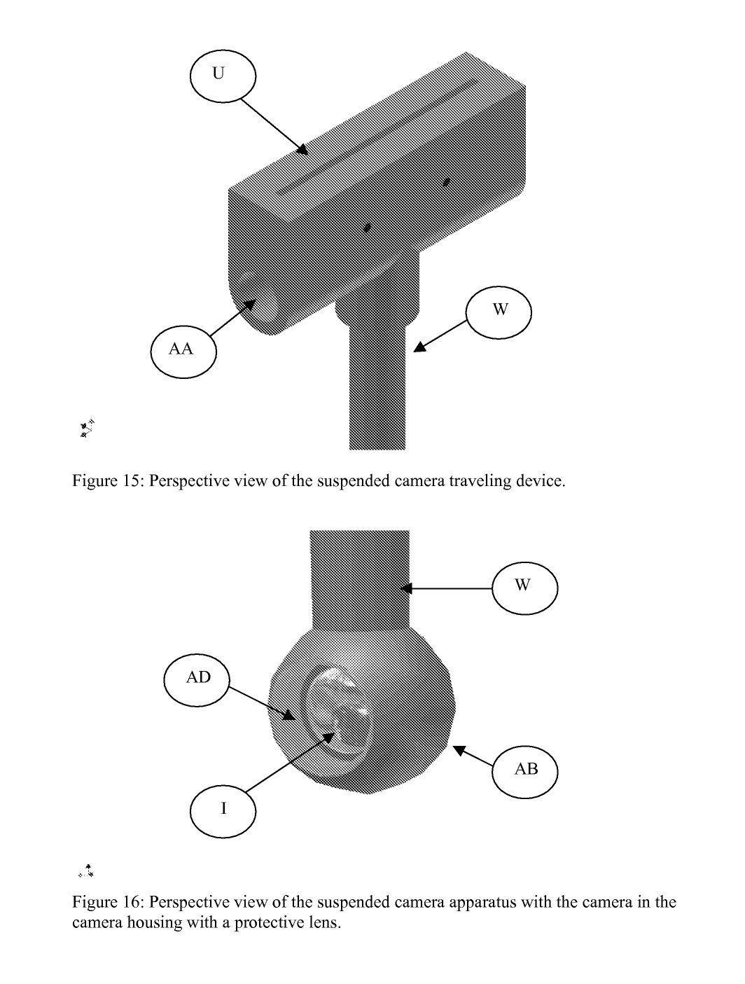

FIG. 15 is a close up perspective view of the traveling device (U) for the suspended camera apparatus. The telescoping pole (W) is attached to the bottom of the traveling device (U). The traveling device (U) travels along a cord suspended above the water surface of the wave pool. In the preferred embodiment the cord inserts into the traveling device (U) at the guide hole (AA).

Referring to FIG. 15, for example, if the suspended cord (R not shown see FIG. 13) were a chain, then traveling device (U) would house the gear box to travel along the chain.

FIG. 16 is a perspective view of the suspended camera apparatus with the suspended camera (I) in a camera housing (AB) with a protective lens (AD). The camera housing (AB) is attached to an extremity of the telescoping pole (W). This camera housing can be used to film the surfer from inside or outside the water body of breaking wave.

Referring to FIG. 16, the camera housing (AB) and the lens (AD) are both water resistant. The spherical shape of the camera housing (AB) is designed to resist the friction and hydrodynamic drag induced by traveling underwater in the water body of the breaking wave. This hydrodynamic design also limits cavitations and the formation of air bubbles on the lens (AD) that would constrict the view of the camera (I)

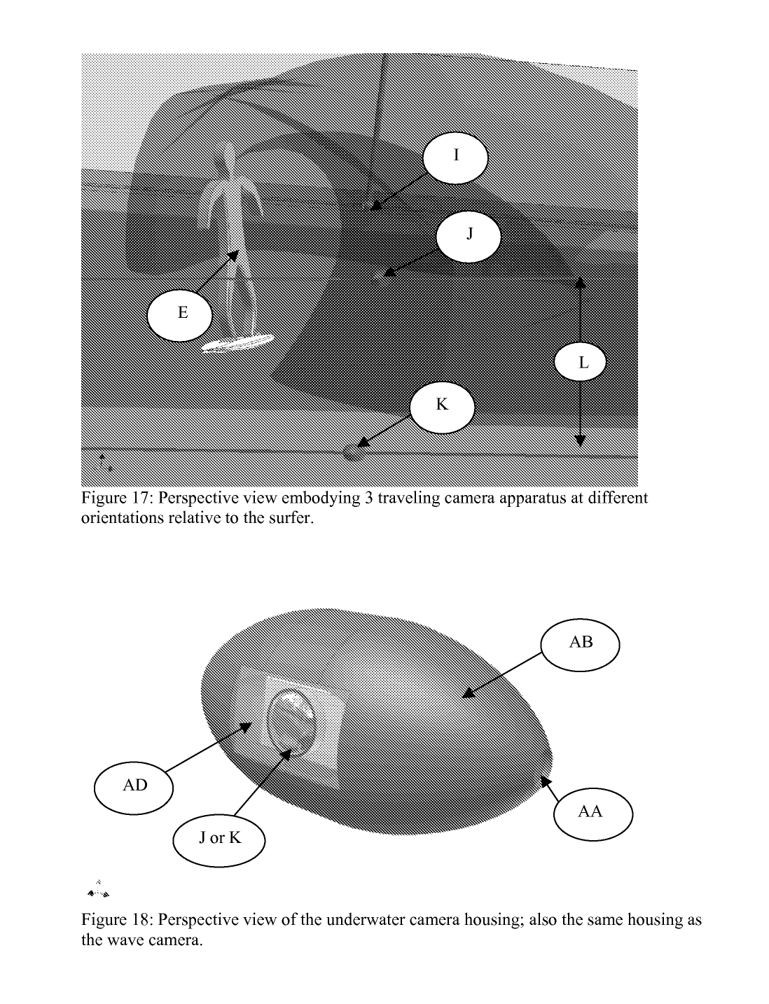

FIG. 17 is a perspective view highlighting 3 camera apparatus at different orientations relative to the surfer (E) that travel along suspension cords (L). The preferred embodiment of the suspended camera (I) is located at head level to the surfer (E) and is submerged in the water body of the breaking wave. The unique filming effect is created when the suspended camera (I) films the surfer through the wave surface of the breaking wave. The image is distorted according to the movement of the water in the water body of the breaking wave.

Referring to FIG. 17, the preferred embodiment of the wave camera (J) is located at waist level to the surfer (E) and is submerged in the water body of the breaking wave. The unique filming effect is created when the wave camera (J) films the surfer through the wave surface of the breaking wave. The image is distorted according to the movement of the water in the water body of the breaking wave.

Referring to FIG. 17, the preferred embodiment of the underwater camera (K) is located underwater, underneath the water surface of the wavepool and underneath the surfer (E). The unique filming effect is created when the underwater camera (K) films the surfer through the interface at the water surface of the wavepool. The unique filming effect is also affected by the movement of the water body of the breaking wave if the underwater camera (K) looks at the surfer through the water body of the breaking wave.

FIG. 18 is a perspective view of the camera housing used for the wave camera (J) and the underwater camera (K) (see FIG. 17). The camera housing (AB) is of conical design and optimum hydrodynamic design to optimize velocity through the water and minimize drag induced by the friction of the water. This hydrodynamic design also limits cavitations and the formation of air bubbles on the lens (AD) that would constrict the view of the wave camera (J) or underwater camera (K).

Referring to FIG. 18, the camera housing (AB) has a guide hole (AA) feature to allow the camera housing (AB) to move in the wavepool along a suspension system. The camera housing (AB) contains wave camera (J) or underwater camera (K) that views the subject through the protective lens (AD).

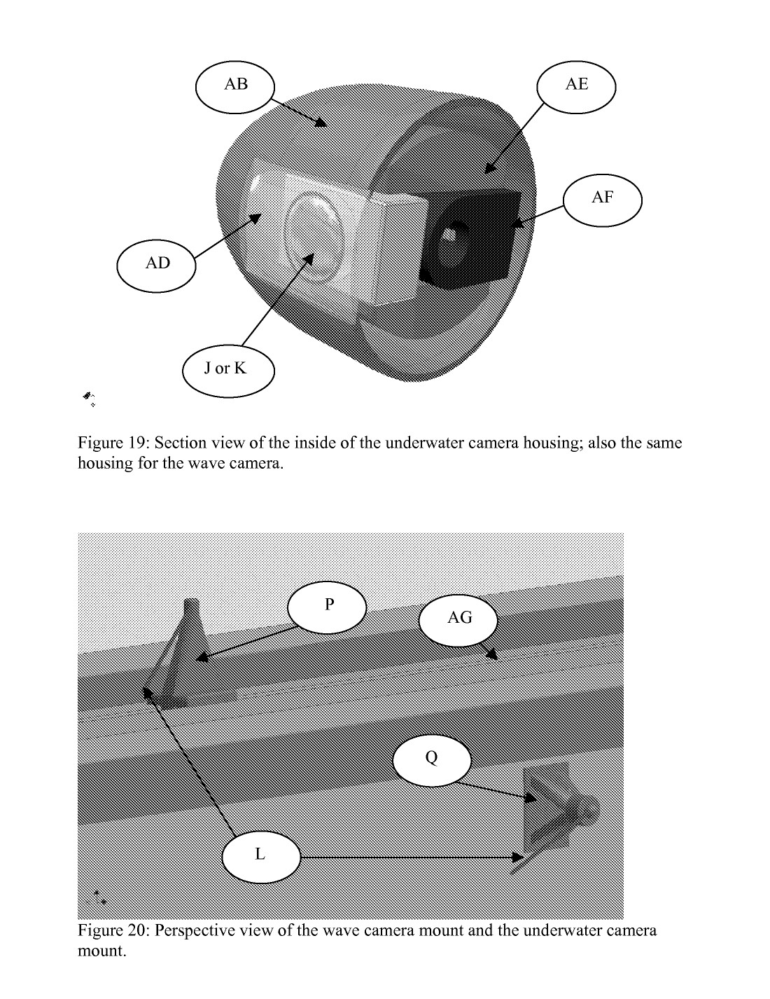

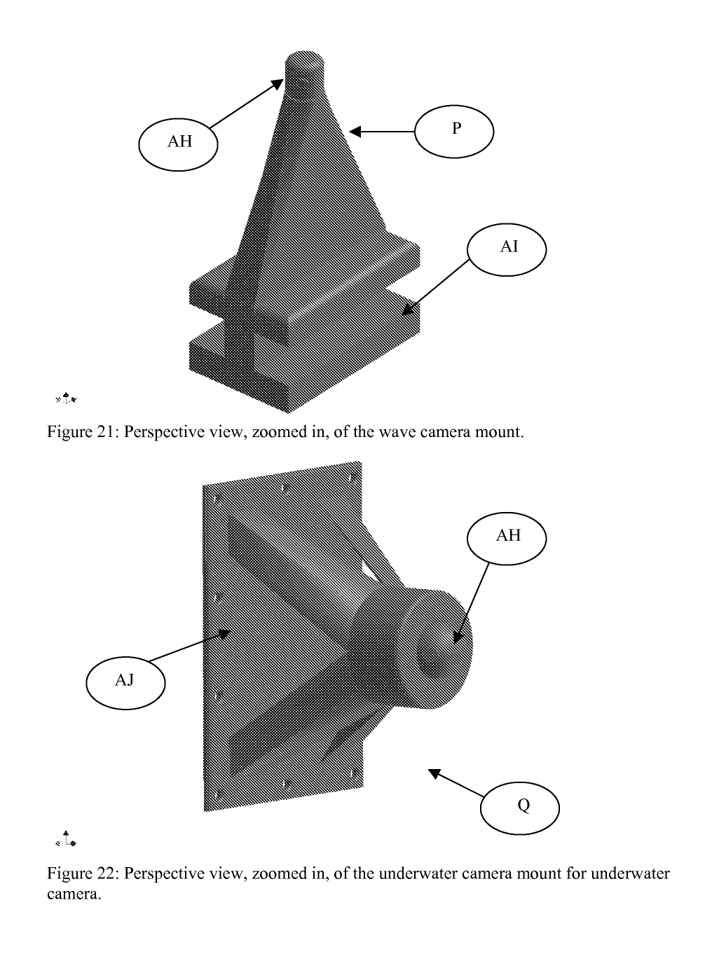

FIG. 19 is a section view of FIG. 21 showing the inside of the underwater camera housing (K); also the same housing used for the wave camera (J) seen in FIG. 17. The illustration exhibits some examples of major internal components inside the camera housing (AB). The camera housing (AB) contains batteries (AE), a motor or mechanical device (AF), and a camera (J) or (K).

Referring to FIG. 19, the motor or mechanical device (AF) is used to move the camera housing (AB) along a cord (L not shown see FIG. 17) and propel the camera housing (AB) through the water.

FIG. 20 is a perspective view of the wave camera mount (P) and the underwater camera mount (Q). The camera mounts are first introduced in FIG. 9. The camera mounts support the cords (L) that spans the width of the wavepool.

Referring to FIG. 20, a wave camera mount (P) is mounted on either side of the wavepool to secure the cord (L). The wave camera mounts (P) are mounted on the surface of the wavepool in order to let cord (L) pass through the water body of the breaking wave (see FIG. 17). The wavepool surface track (AG) allows the wave camera mount (P) to be moved along the side of the pool to reconfigure path (C) created by the span of cord (L). This changeable positioning of the camera mounts (P) allows the operator to configure the path of the wave camera (J) to follow the path of the breaking wave and the surfer as they travel across the wavepool.

Referring to FIG. 20, the underwater camera mounts (Q) are mounted on the walls of the wave pool, underneath the water surface of the wavepool in order to film the surfer (E) from an underwater perspective. The underwater camera mount (Q) is attached semi-permanently in order to reconfigure path (C) created by the span of cord (L). This changeable positioning of the camera mounts (Q) allows the operator to configure the path of the underwater camera (K) to follow the path of the breaking wave and the surfer as they travel across the wavepool.

FIG. 21 is a perspective view of the wave camera mount (P). The wave camera mount (P) has a swivel attachment unit (AH) that couples to cord (L).

Referring to FIG. 21, as an example, the wave camera mount also has a male sliding structure (AI) that inserts into the female couple of wavepool surface track (AG see FIG. 203). The orientation of the swivel attachment unit (AH) and the position of the wave camera mount (P) in the surface track (AG) determine the orientation of cord (L) and the ultimate path that the wave camera travels.

FIG. 22 is a perspective view of underwater camera mount (Q) for the underwater camera (K). The underwater camera mount (Q) has a swivel attachment unit (AH) that couples to cord (L).

Referring to FIG. 22, as an example, the underwater camera mount has a bolted mounting plate (AJ) that attaches the underwater camera mount (Q) to an underwater side wall of the wave pool. The orientation of the swivel attachment unit (AH) and the position of the wave camera mount (Q) on the side wall of the wavepool attached by bolt mounting plate (AI) determines the orientation of cord (L) and the ultimate path that the wave camera travels.

Referring to FIG. 22, the bolting plate mount provides an example of how the underwater camera mount can be mounted to the side wall of the wavepool. It should be noted that the mounting ability of the wave camera mount (P see FIG. 21) and the underwater camera mount (Q) can be interchanged depending on ultimate design and configuration of the operator. For example, the underwater camera (Q) mount can have a male sliding attachment unit (AI) and a track along the side wall of the wavepool similar to the wavepool surface track (AG).

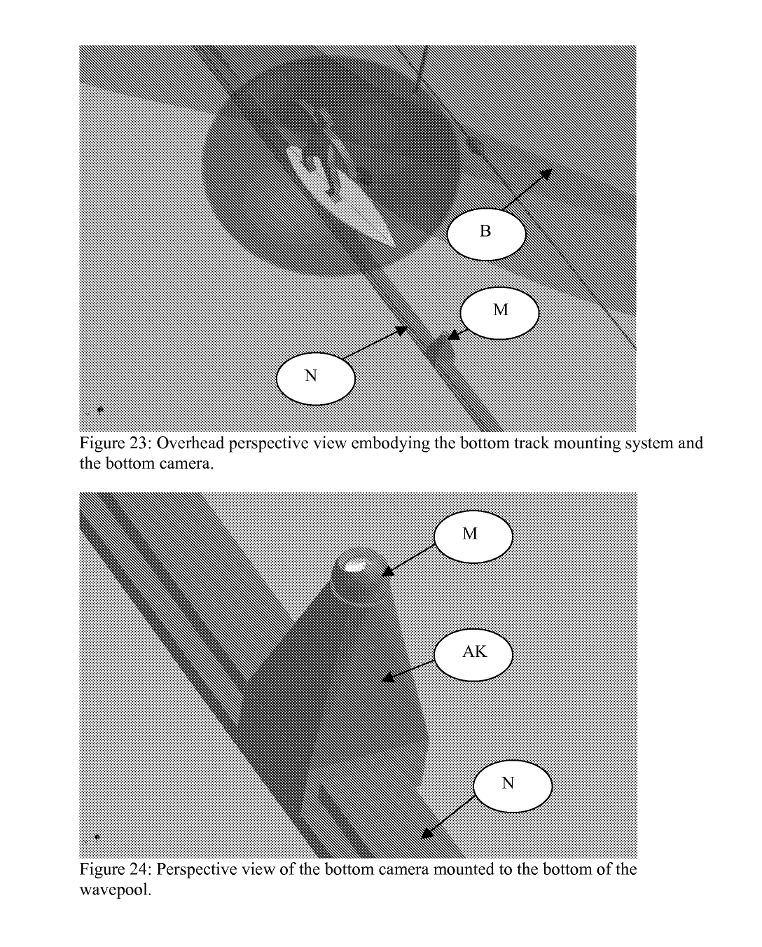

FIG. 23 is an overhead perspective view highlighting bottom track mounting system (N) and bottom camera (M). Similar to the wave camera (J) traveling along cord (L) (see FIG. 17); the bottom camera (M) travels along the bottom track (N) while filming the surfer riding on the breaking wave.

Referring to FIG. 23, the bottom track (N) is semi-permanently affixed to the bottom of the wavepool. This allows the operator to reposition the bottom track (N) in order to accommodate a different wave path (C) followed by the surfer and the breaking wave.

FIG. 24 is a perspective view of bottom camera (M) mounted to the bottom of the wavepool and allowed to travel along bottom track (N).

Referring to FIG. 24, as an example, bottom mounting system (AK) has a female coupling that joins the male coupling of bottom track (N). It should be noted that any of the mounting system configurations of the cameras may be interchanged. Other examples of mounting systems include magnets, adhesive, straps, threaded inserts, shackles, and snaps.

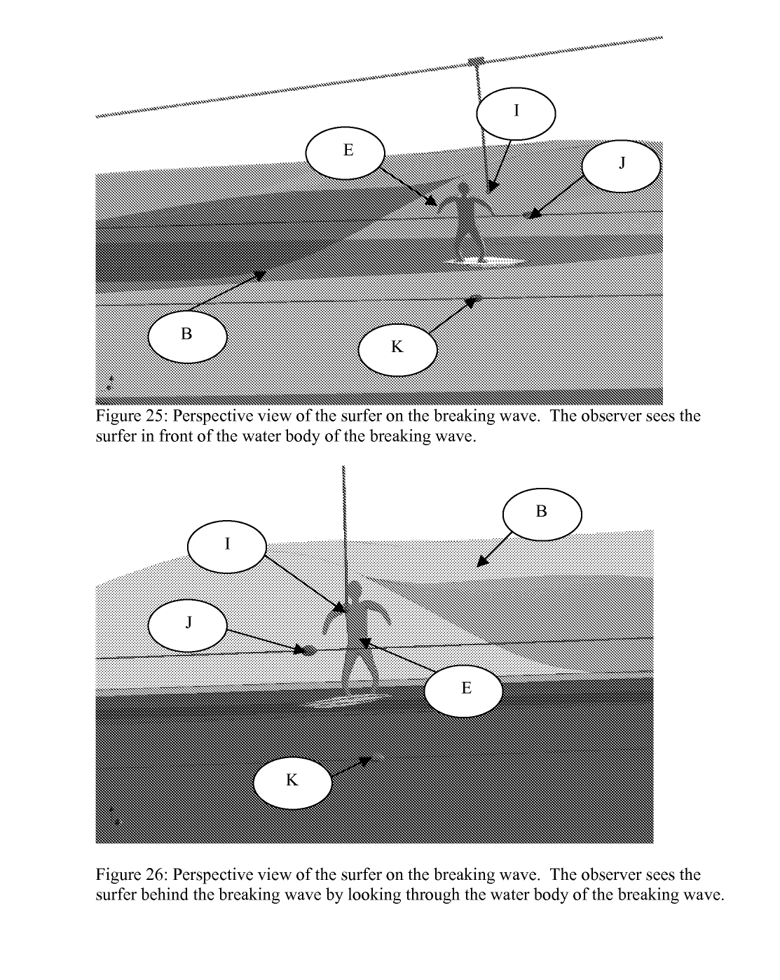

FIG. 25 is a perspective view of the surfer (E) on the breaking wave (B). The observer sees the surfer (E) in front of the water body of the breaking wave (B). All three of the cameras the underwater camera (K), the wave camera (J), and the suspended camera (I) are examples of the preferred embodiment.

Referring to FIG. 25, all three of the cameras capture the motion of the surfer on the breaking wave as the cameras move according to the displacement of the surfer and the breaking wave.

Referring to FIG. 25, all three of the cameras are submerged and their vision is distorted by the water/wave surface and air interface. Obtaining this distorted image of the surfer through the water/wave surface and air interface is the objective of the Traveling Camera Apparatus for Surfing.

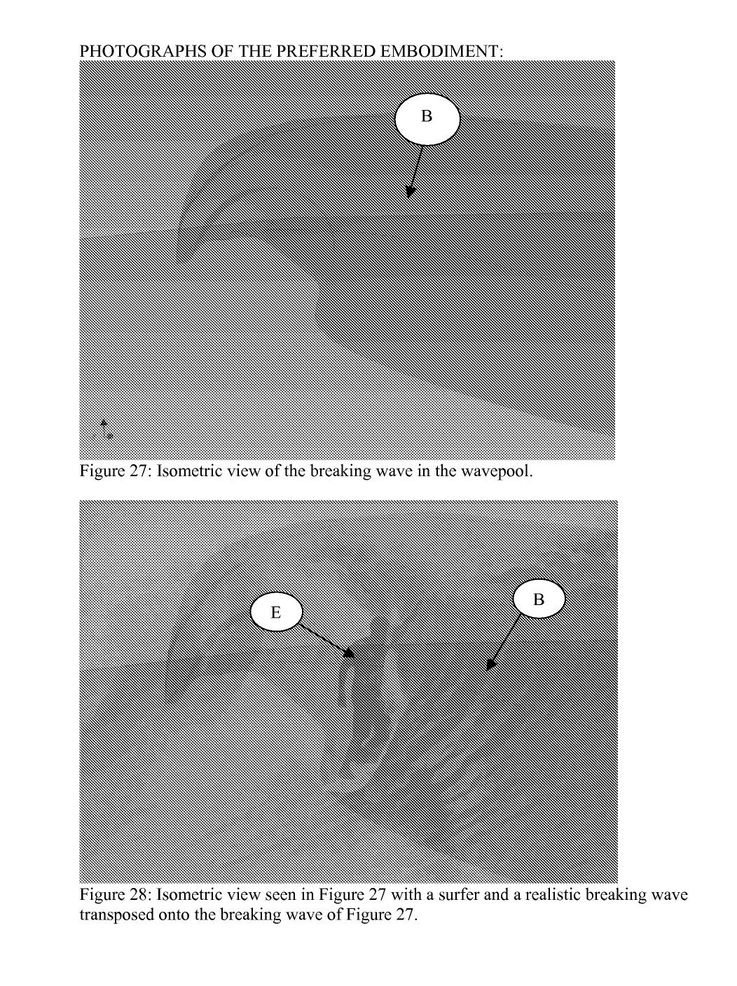

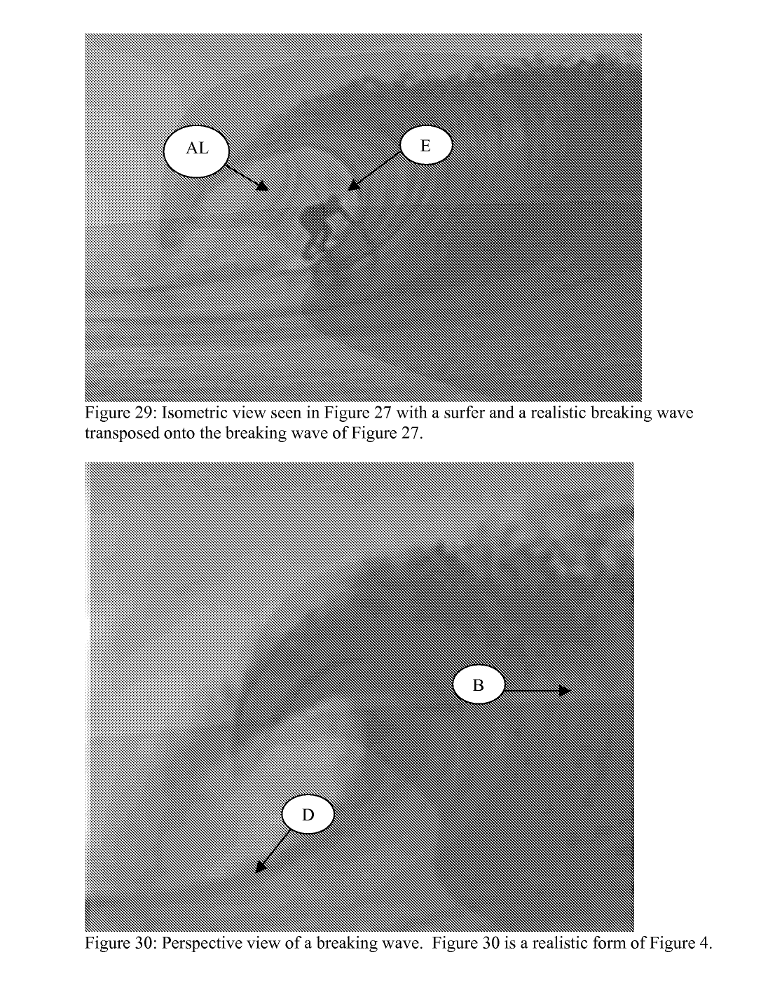

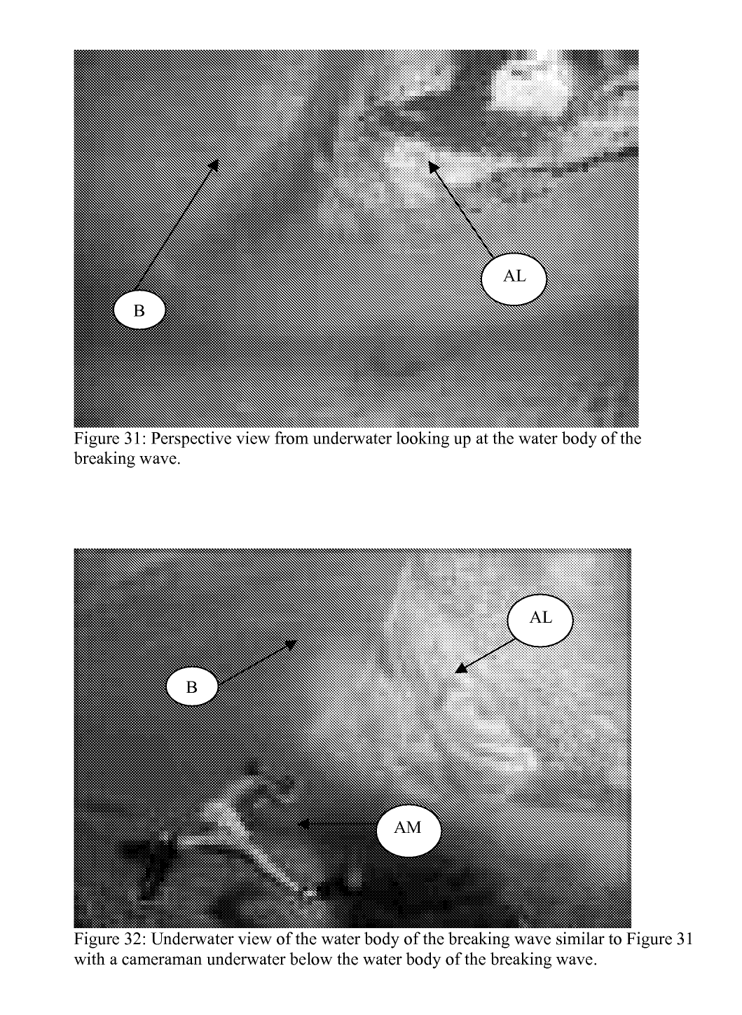

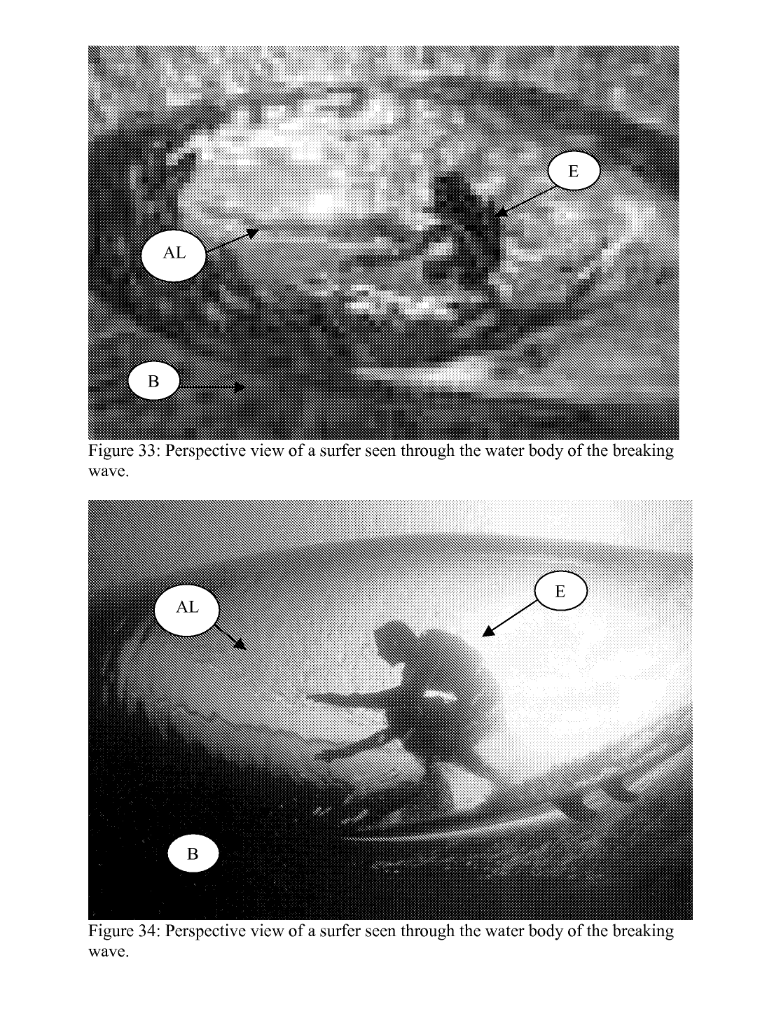

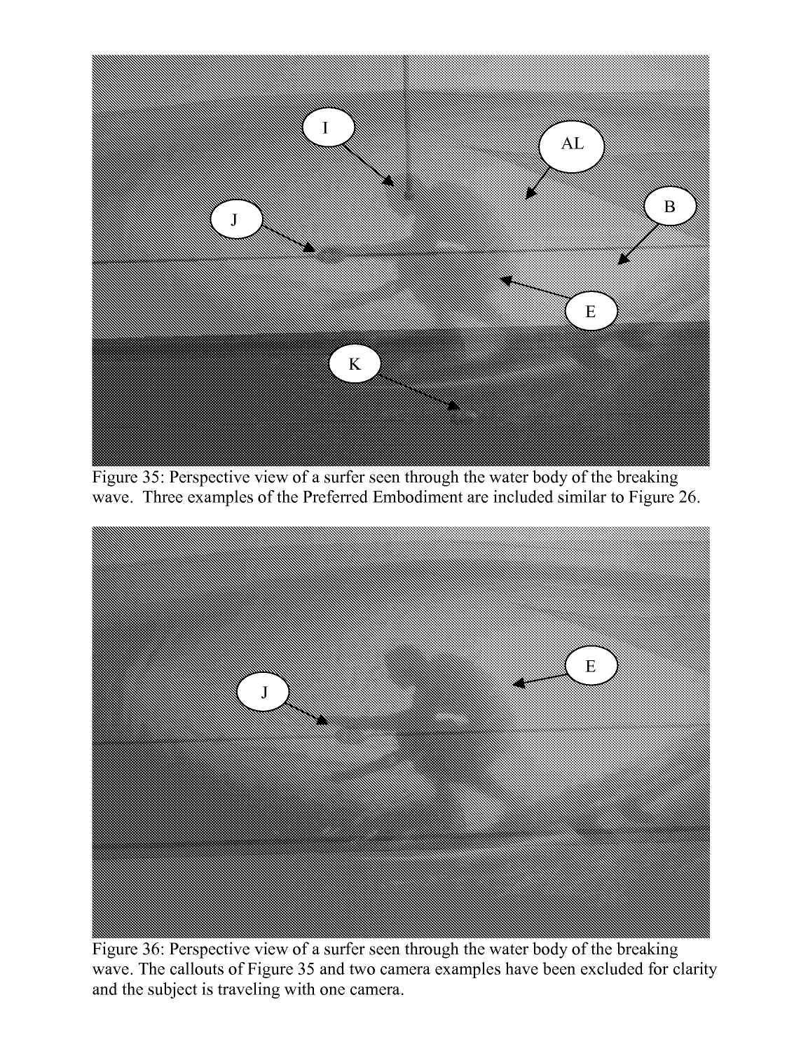

FIG. 26 is a perspective view of the surfer (E) on the breaking wave. The observer sees the surfer (E) behind the water body of the breaking wave (B) by looking through the water body of the breaking wave (B). All three of the cameras; the underwater camera (K), the wave camera (J), and the suspended camera (I) are examples of the preferred embodiment.

Referring to FIG. 26, all three of the cameras film the motion of the surfer on the breaking wave (B) as the cameras move according to the displacement of the surfer and the breaking wave.

Referring to FIG. 26, all three of the cameras are submerged and their vision is distorted by the water/wave surface and air interface. This distorted image of the surfer is the objective of the Traveling Camera Apparatus for Surfing.

### BRIEF DESCRIPTION OF THE DRWAWINGS

FIG. 27 is an isometric view of the breaking wave (B) in the wavepool.

FIG. 28 is the same breaking wave seen in FIG. 27 with a graphic layer of a surfer (E) riding the breaking wave.

FIG. 29 is yet another example of a surfer riding the breaking wave seen in FIG. 27.

FIG. 30 is yet another example of the breaking wave seen in FIG. 27. FIG. 30 is the same breaking wave seen in FIG. 27 with a graphic layer of a breaking wave.

FIG. 31 is a perspective view of the breaking waves in FIGS. 27 to 30 seen from underneath the water body of the breaking wave (B).

FIG. 32 shows a camera man (AM) positioned underwater underneath the water body of the breaking wave (B).

FIG. 33 is an example of a photograph that the camera man of FIG. 32 shall take when positioned submerged underneath the water body of the breaking wave (B).

FIG. 34 is yet another example of a photograph that the camera man of FIG. 32 shall take when positioned submerged underneath the water body of the breaking wave (B).

FIG. 35 is the same as the example seen in FIG. 34 with three camera examples of the preferred embodiment.

FIG. 36 is yet another example of the preferred embodiment. The fundamental nature of the invention is to capture images similar to FIG. 36.

### DETAILED DESCRIPTION OF THE PREFFERED EMBODIMENT

FIG. 27 to 36 are examples of viewpoints that the invention shall obtain within the scope of the preferred embodiment set forth in this report. FIGS. 27 to 36 depict realism and are a necessary tool to fully conceptualize the utility of the invention.

FIG. 27 is an isometric view of the breaking wave (B) in the wavepool. The 3D image adapts more realism with the isometric view. FIG. 27 is similar to the breaking wave seen in FIG. 4.

FIG. 28 is the same breaking wave seen in FIG. 27 with a graphic layer of a surfer (E) riding the breaking wave. FIG. 28 is an artistic rendition used to visualize the behavior of a subject riding on the breaking wave (B).

FIG. 29 is yet another example of a surfer riding the breaking wave seen in FIG. 27. FIG. 29 is the same breaking wave seen in FIG. 27 with a graphic layer of a surfer (E) riding the breaking wave. FIG. 29 is an artistic rendition used to visualize the behavior of a subject riding on the breaking wave (B).

Referring to FIG. 29, the subject (E) is riding the breaking wave by being positioned inside the curl or tube (AL) of the breaking wave. A wave breaking with this shape is termed a plunging wave in the related scientific field. It shall be noted and deemed true that within the sport of surfing it is desirable to ride a breaking wave while being inside this hollow portion of the breaking wave. This principle is paramount to the understanding of the preferred embodiment and shall be swiftly realized by those trained in the art.

FIG. 30 is yet another example of the breaking wave seen in FIG. 27. FIG. 30 is the same breaking wave seen in FIG. 27 with a graphic layer of a breaking wave. FIG. 30 is an artistic rendition used to visualize another principle indispensable to the understanding of the preferred embodiment. FIG. 30 shows that the water body of the breaking wave (B) is above the water surface of the wave pool (D). It shall be stated that an underwater camera can be placed inside the water body of the breaking wave (B) and also be above the water body of the wavepool (D).

FIG. 31 is a perspective view of the breaking waves in FIGS. 27 to 30 seen from underneath the water body of the breaking wave (B). The hollow inside portion of the wave (AL) shall be seen as well, however distorted by looking through the water. This image shall be seen by a camera or a person submerged in the water body of the wave pool while the breaking wave propagates overhead.

FIG. 32 is a perspective view similar to FIG. 31. The breaking wave seen in FIG. 32 is similar to the breaking wave of FIG. 31. FIG. 32 shows a camera man (AM) positioned underwater underneath the water body of the breaking wave (B).

FIG. 33 is an example of a photograph that the camera man of FIG. 32 shall take when positioned submerged underneath the water body of the breaking wave (B). The subject of FIG. 33 (E) is traveling with the breaking wave positioned inside the hollow portion of the breaking wave (AL).

Referring to FIG. 33, the image is distorted by the effects of looking through the water body of the breaking wave. It shall be understood that the surfer propagates along the breaking wave much faster than the camera man can swim underwater. Furthermore, the camera man can only photograph or film the subject passing on the breaking wave from this single point. The preferred embodiment of the invention requires that a camera travel along with the subject while the subject interacts with the breaking wave.

FIG. 34 is yet another example of a photograph that the camera man of FIG. 32 shall take when positioned submerged underneath the water body of the breaking wave (B).

The subject of FIG. 34 (E) is traveling with the breaking wave positioned inside the hollow portion of the breaking wave (AL).

FIG. 35 is the same as the example seen in FIG. 34. In FIG. 35 the three camera examples of the preferred embodiment (I), (J), and (K) have been included. FIG. 35 is similar to FIG. 26 in that all three of the cameras; the underwater camera (K), the wave camera (J), and the suspended camera (I) are examples of the preferred embodiment. Each of these cameras travels along with the subject (E) as they ride the breaking wave. The cameras shall record images similar to those seen in FIGS. 33 and FIG. 34.

FIG. 36 is yet another example of the preferred embodiment. The fundamental nature of the invention is to capture images similar to FIG. 36. In the preferred embodiment, the camera (J) shall video the surfer (E) throughout the entire propagation of the breaking wave.

Referring to FIG. 36, the preferred embodiment of the invention is to capture video footage of the subject as stated in the disclosure of the invention and as exemplified by FIG. 36.

What is claimed is:

1. The Traveling Camera Apparatus for Surfing shall be an apparatus comprising:
A camera to photograph or video a subject on a breaking wave.
A camera housing to secure and protect the said camera and to also allow the said camera to be operated underwater.
A traveling device that allows the said camera housing to move with the motion of the said subject on the said breaking wave.
A suspension system used to span a wavepool and to support the path of the said traveling device.
A mounting system to secure the said suspension system to the said wavepool.

2. The said apparatus set forth in claim 1 designed to function in the said wavepool and to film or photograph the interaction of the said subject and the said breaking wave. The said breaking wave will propagate a desired length in the said wavepool in which the said subject shall interact with the said breaking wave.

3. The said apparatus of claim 1 shall interact with both the said subject and the said breaking wave whereby all three components interact simultaneously. The said apparatus shall interact with the said breaking wave even if no said subject is interacting with the said breaking wave.

4. More than one said subject may interact with a single said breaking wave at any given time. More than one said subject may interact with the said apparatus at any given time. The said wavepool may contain any number of said subjects, said breaking waves, and said apparatus as governed by the capacity of the said wavepool.

5. The said apparatus of claim 1 interacting with the said subject and said breaking wave as set forth in claim 2 shall be free to travel relative to the said subject with any orientation including but not limited to with the said subject, in front of the said subject, behind the said subject, under the said subject, above the said subject, adjacent to the said subject, alongside the said subject, in any orientation relative to the said subject, and in any proximity to the said subject.

6. The said apparatus of claim 1 interacting with the said subject and said breaking wave as set forth in claim 2 will be free to travel relative to the said breaking with any orientation including but not limited to with the said breaking wave, in front of the said breaking wave, behind the said breaking wave, under the said breaking wave, above the said breaking wave, adjacent to the said breaking wave, alongside the said breaking wave, submerged in the said breaking wave, on the surface of the said breaking wave, outside of the water body of the said breaking wave, inside the water body of the said breaking wave, in any orientation relative to the said breaking wave, and in any proximity to the said breaking wave.

7. The said camera of claim 1 shall be of the type digital or photographic.

8. The said camera will be variably configurable to optimally capture the said subject depending on the desired function specified by an operator.

9. The said camera will be variably configurable to optimally capture the said subject from any said orientation set forth in claim 5.

10. The said camera will be variably configurable to optimally capture the said breaking wave from any said orientation set forth in claim 6.

11. The said camera as set forth in claim 1 shall be attached to the said camera housing of claim 1. The said camera housing shall protect and secure said camera and allow the said camera to be operated underwater.

12. The said camera housing will have functionality in order to allow the said camera to view the said subject with any said orientation as set forth in claim 5.

13. The said camera housing will have functionality in order to allow the said camera to view the said breaking with any said orientation as set forth in claim 6.

14. The said camera housing as set forth in claim 1 shall be attached to the said traveling device of claim 1.

15. The said traveling device will have functionality in order to allow the said camera housing to move with the said subject in order to maintain any orientation as set forth in claim 5.

16. The said traveling device will have functionality in order to allow the said camera housing to move with the said breaking wave in order to maintain an orientation as set forth in claim 6.

17. The said traveling device will supply the means for the said camera and the said camera housing to travel a path that spans the said wavepool.

18. The said traveling device of claim 1 shall be incorporated into the said camera housing of claim 1.

19. The said traveling device of claim 1 shall be incorporated into the said mounting system of claim 1.

20. The path traveled by the said traveling device shall be governed according to the said suspension system of claim 1.

21. The said suspension system as set forth by claim 1 will be attached to the said wavepool by the said mounting system of claim 1. The said suspension system shall be an elongated structure that spans the said wavepool. The said suspension system shall terminate at the said mounting system.

22. The said mounting system shall be any structure that accepts the termination end of the suspension system and attaches the said suspension system to the said wavepool.

23. The said mounting system as set forth by claim 1 will be fixed permanently or semi-permanently to the said wavepool and be variable configurable to adjust to different paths of travel of the said subject and the said breaking wave as specified by an operator.
